(19) United States
(12) Patent Application Publication
(10) Pub. No.: US 2002/0008757 A1
(43) Pub. Date: Jan. 24, 2002

(54) Stereoscopic picture image forming apparatus

(76) Inventors: Seiji Sato, Kanagawa (JP); Akira Kawamura, Kanagawa (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/859,777

(22) Filed: May 17, 2001

(30) Foreign Application Priority Data
May 17, 2000 (JP) P2000-144822

(51) Int. Cl. H04N 13/02; H04N 15/00

(52) U.S. Cl. 348/47

(57) ABSTRACT

A stereoscopic picture image forming apparatus forms a picture image of an object separated into a first sub-object for a left eye and a second sub-object for a right eye. The stereoscopic picture image forming apparatus includes: a camera; a lens; a left charge coupled device for picking up the picture image for the left eye, which picture image is introduced by way of the lens; and a right charge coupled device for picking up the picture image for the right eye, which picture image is introduced by way of the lens.

### RELATED APPLICATION DATA

The present application claims priority to Japanese Application No. P2000-144822 filed May 17, 2000, which application is incorporated herein by reference to the extent permitted by law.

### BACKGROUND OF THE INVENTION

The present invention relates to a stereoscopic picture image forming apparatus for forming stereoscopic picture images.

FIG. 4 shows a stereoscopic picture image forming apparatus according to an earlier technology. The stereoscopic picture image forming technique shown in FIG. 4 is sometimes referred to as a sidewise running technique. FIG. 4(a) shows a spatial relationship between a scene object and a camera 1 before camera movement, and FIG. 4(b) shows a spatial relationship after the camera movement.

Before the camera movement, the camera 1 is held at a first position and operated to take an picture image of each of a first object A and a second object B, as is seen in FIG. 4(a). The second object B is more distant from the camera 1 than the first object A is. A one-dot chain line shown in FIG. 4(a) is an imaginary straight connecting line passing through the first object A and the second object B. The imaginary straight connecting line is substantially perpendicular to an image plane of an imager 2 (in other words, an image pick-up means 2, or an image pick-up element 2; hereinafter referred to as “CCD 2”, in which CCD is an acronym of “charge coupled device”). An optical axis (passing through the center of a lens 3 of the camera 1) of the camera 1 shown by a two-dot chain line is substantially parallel to the imaginary straight connecting line, and is located on the left side of the imaginary straight connecting line at a length L1. In this state, the first object A and the second object B form respective images at a first image position Al and a first image position B1 in the image plane of the CCD 2.

Then, the camera 1 is moved in a manner of translational motion in parallel to the image plane of the CCD 2 of the camera 1, as shown by an arrow in FIG. 4(a), to the state shown in FIG. 4(b). In the state of FIG. 4(b) reached after the camera movement, the optical axis of the camera 1 is located on the right side of the imaginary straight connecting line passing through the first object A and the second object B, at the length L1 from the imaginary straight connecting line. The first object A and the second object B form respective images at a second image position A2 and a second image position B2 in the image plane of the CCD 2.

The picture images thus formed before and after the camera movement are displayed in a stereoscopic visualization display device using shutter glasses capable of controlling light transmission and light blockade for stereoscopic visualization as shown in FIG. 5(a) and FIG. 5(b). The thus displayed picture images are reversed picture images formed on the CCD 2. A display picture image 13 is obtained by alternately displaying a first picture image 11 formed before the camera movement and a second picture image 12 formed after the camera movement.

A shutter 14a is so controlled that a viewer can view the first picture image 11 before the camera movement with the left eye 15 and the second picture image 12 after the camera movement with the right eye 16. Three-dimensional effect is achieved due to parallax, and the images of the first object A and the second object B jut forward in front of a display screen.

FIG. 6 shows, as an example, a stereoscopic display system. There are provided a video camera 20, a reproducing apparatus 21, a control device 22, and a display device 23. The first picture image 11 (before camera movement) is displayed on even-numbered fields, and the second picture image 12 (after camera movement) is displayed on odd-numbered fields. A viewer puts on an eyewear 14 in the form of shutter glasses 14 and sees displayed picture images. The control device 22 controls the eyewear 14 (shutter 14a). Under the control of the control device 22, the eyewear 14 is put in a left open state on the even-numbered fields and in a right open state on the odd-numbered fields. In the left open state, a left piece (of the eyewear 14) for the left eye 15 is in a transparent state for permitting transmission of light while a right piece (of the eyewear 14) for the right eye 16 is in an opaque state for blocking passage of light. In the right open state, the left piece (of the eyewear 14) for the left eye 15 is in the opaque state for blocking light while the right piece (of the eyewear 14) for the right eye 16 is in the transparent state for permitting transmission of light. Thus, the viewer can view a stereoscopic picture image as shown in FIG. 6.

As is seen in FIG. 7, there is provided a stereoscopic picture image forming apparatus based on the above mentioned principles, according to the earlier technology. In front of the lens 3 of the camera 1, there is provided an optical system 25 as an optical means for separating a left picture image L for the left eye from a right picture image R for the right eye.

The optical system 25 is constituted of a pair of a first right mirror 31R1 and a first left mirror 31L1, and a pair of a second right mirror 31R2 and a second left mirror 31L2. The pair of the first right mirror 31R1 and the first left mirror 31L1 are disposed on an external peripheral side (upper in FIG. 7) of the camera 1 in such a manner as to oppose to each other, each of which forming a predetermined angle (for example, 45°) with respect to the lens 3. The second right mirror 31R2 and the second left mirror 31L2 are disposed, respectively, substantially in parallel with the first right mirror 31R1 and the first left mirror 31L1, and are also disposed in such a position as to oppose to the lens 3. The thus constituted optical system 25 provides a left optical axis 30L and a right optical axis 30R. The right optical axis 30R is distant from the left optical axis 30L by a distance D. The distance D is a factor for determining the parallax, and is equivalent to an eye width (scale spacing). Namely, the distance D is a length between the left eye and the right eye.

More specifically, a formed image corresponding to the one that is viewed from the left eye is focused into a left half and enters the lens 3, while a formed image corresponding to the one that is viewed from the right eye is focused into a right half and enters the lens 3. Then, the picture image around the left optical axis 30L on the left side is formed on the right half of the CCD 2, while the picture image around the right optical axis 30R on the right side is formed on the left half of the CCD 2.

As is seen in FIG. 8(a), there is provided the picture image displayed by means of the stereoscopic picture image forming apparatus in FIG. 7. Each of the left picture image L and the right picture image R is signal-processed, to thereby allow the left picture image L and the right picture image R to correspond, respectively, to the even-numbered fields and the odd-numbered fields. Thereby, the stereoscopic display system (for example, the one shown in FIG. 6) allows the viewer to view a stereoscopic picture image.

As is seen in FIG. 8(a), however, displaying the left picture image L into the one shown in FIG. 8(b) and the right picture image R into the one shown in FIG. 8(c), each at an aspect ratio same as that of FIG. 8(a), requires cutting off an upper portion and a lower portion {see shaded areas (diagonals) in FIG. 8(a)}. Therefore, the number of pixels (picture elements) that can be displayed on the picture image of each of the even-numbered fields and the odd-numbered fields is reduced to ¼ of the number of pixels of the original CCD 2.

More specifically, forming two picture images (whose sight lines are separated) with one image pick-up means (CCD 2) reduces the number of pixels of one picture image (½ reduction in a sideward direction). Moreover, displaying the thus obtained picture image at a standard aspect ratio discards another ½. As a result, the number of pixels displayed is reduced to ¼, ending up deterioration in video quality of the picture image displayed.

### SUMMARY OF THE INVENTION

It is therefore an object of the present invention to provide a stereoscopic picture image forming apparatus for obtaining a stereoscopic picture image with high resolution.

It is another object of the present invention to prevent deterioration in video quality of the stereoscopic picture image forming apparatus.

According to the present invention, there is provided a stereoscopic picture image forming apparatus for forming a picture image of an object separated into a first sub-object for a left eye and a second sub-object for a right eye. The stereoscopic picture image forming apparatus includes: a common image-forming means; a first image pick-up means for picking up the picture image for the left eye, which picture image is introduced by way of the common image-forming means; and a second image pick-up means for picking up the picture image for the right eye, which picture image is introduced by way of the common image-forming means.

The other objects and features of the present invention will become understood from the following description with reference to the accompanying drawings.

### BRIEF DESCRIPTION OF THE DRAWINGS

FIG. 1 is a constitution of a stereoscopic picture image forming apparatus, according to a first preferred embodiment of the present invention;

FIG. 2 is a picture image formed by means of the stereoscopic picture image forming apparatus in FIG. 1, in which,

FIG. 2(a) is a picture image formed by means of a left image pick-up means 32L, and

FIG. 2(b) is a picture image formed by means of a right image pick-up means 32R;

FIG. 3 is a constitution of a stereoscopic picture image forming apparatus, according to a second preferred embodiment of the present invention;

FIG. 4 shows a principle of forming a stereoscopic picture image, which principle is referred to as a sidewise running technique, in which,

FIG. 4(a) shows a spatial relationship between a scene object and a camera 1 before camera movement, and

FIG. 4(b) shows a spatial relationship between the scene object and the camera 1 after the camera movement;

FIG. 5 shows the principle of forming the stereoscopic picture image in relation to FIG. 4, in which,

FIG. 5(a) shows a first picture image 11 before camera movement and a second picture image 12 after camera movement, and

FIG. 5(b) shows a display picture image 13;

FIG. 6 shows an example of a stereoscopic display system for viewing the stereoscopic picture image;

FIG. 7 is a constitution of a stereoscopic picture image forming apparatus, according to an earlier technology; and

FIG. 8(a) is the picture image formed by means of the stereoscopic picture image forming apparatus in FIG. 7,

FIG. 8(b) is an explanatory stereoscopic picture image (left), and

FIG. 8(c) is an explanatory stereoscopic picture image (right).

### DETAILED DESCRIPTION OF THE PREFERRED EMBODIMENT

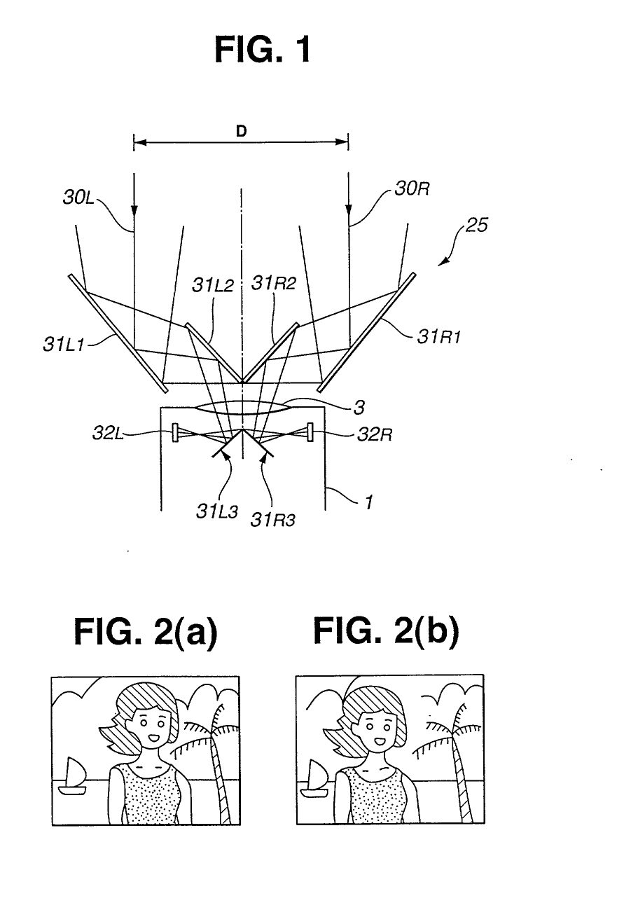

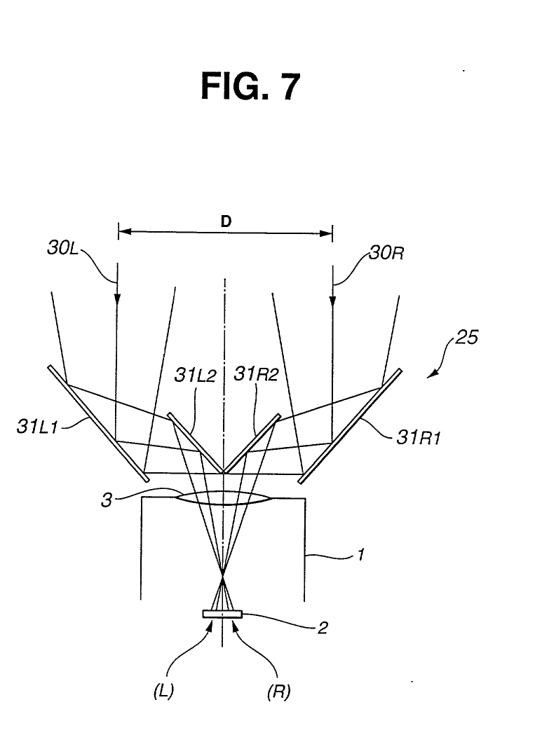

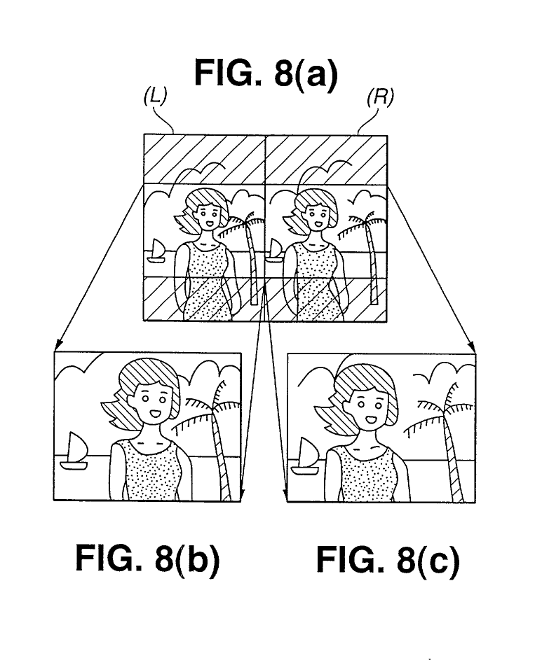

As is seen in FIG. 1, there is provided a stereoscopic picture image forming apparatus, according to a first preferred embodiment of the present invention. Parts and portions substantially the same as those in FIG. 7 (the stereoscopic picture image forming apparatus, according to the earlier technology, as described in BACKGROUND OF THE INVENTION above) are denoted by the same numerals. More specifically, for example, the optical system 25 disposed substantially in a forward portion (upward in FIG. 1) of the lens 3 of the camera 1 is the same as that in FIG. 7.

On an image formation side (lower in FIG. 1) of the lens 3, there are provided a third left mirror 31L3 corresponding to the left optical axis 30L, and a third right mirror 31R3 corresponding to the right optical axis 30R. The third left mirror 31L3 and the third right mirror 31R3 are so disposed as to form a predetermined angle therebetween, to thereby separate an optical path on the left side and the right side. At an image formation position of the left optical axis 30L, there is provided a left CCD 32L, while at an image formation position of the right optical axis 30R, there is provided a right CCD 32R. The thus provided left CCD 32L and the right CCD 32R constitute an image pick-up optical system.

With the above constitution, the left CCD 32L forms the picture image around the left optical axis 30L on the left side, while the right CCD 32R forms the picture image around the right optical axis 30R on the right side.

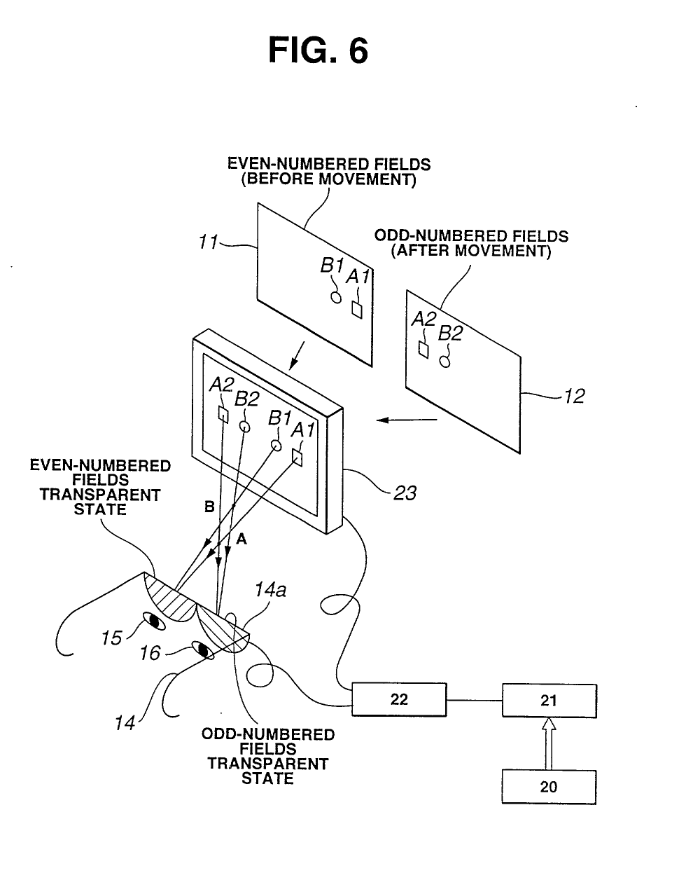

FIG. 2(a) shows the picture image formed by means of the left CCD 32L, while FIG. 2(b) shows the picture image formed by means of the right CCD 32R. Between the two picture images, there is defined a parallax which is based on the distance D (in FIG. 1) from the left optical axis 30L to the right optical axis 30R. The left picture image and the right picture image are signal-processed so as to correspond, respectively, to the even-numbered fields and the odd-numbered fields. Thereby, the stereoscopic display system in FIG. 6 allows the viewer to view a stereoscopic picture image.

With the above constitution, the right picture image can use all pixels (picture elements) of the right CCD 32R for image-forming, while the left picture image can use all pixels of the left CCD 32L for image-forming.

In place of the left CCD 32L and the right CCD 32R, other picture imager (image pick-up means) such as a “complementary metal oxide semiconductor” (hereinafter refereed to as “CMOS”) and the like can be used for the image pick-up means.

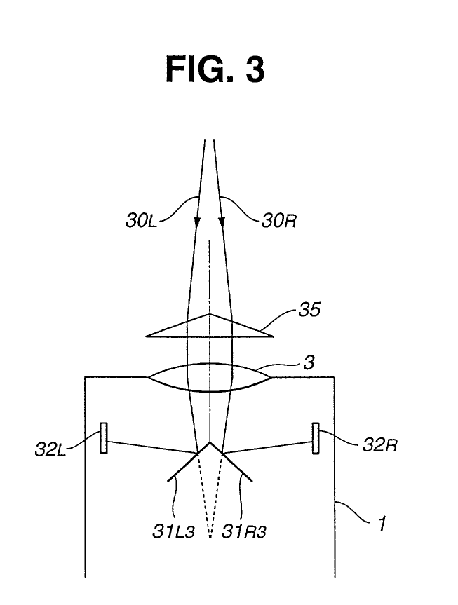

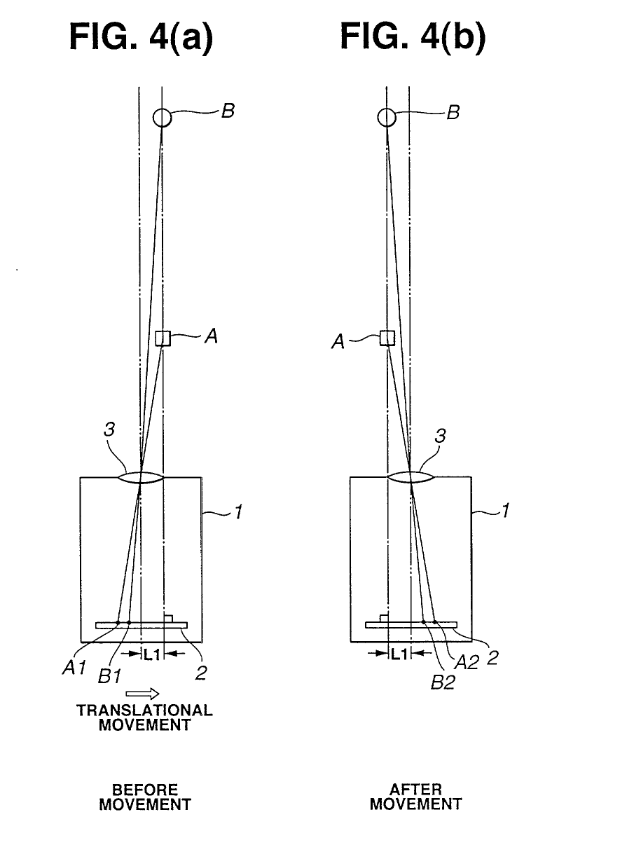

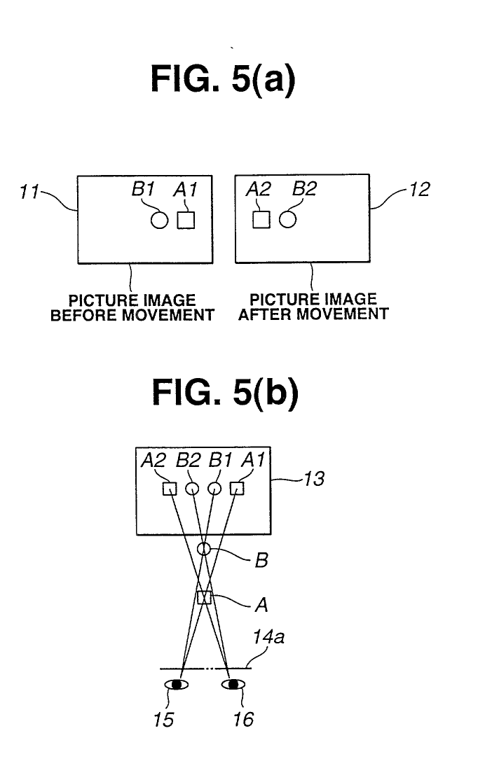

Moreover, there is provided a stereoscopic picture image forming apparatus, according to a second preferred embodiment of the present invention. Parts and portions substantially the same as those in FIG. 1 are denoted by the same numerals. According to the second preferred embodiment, a prism 35 (optical means) having a mountainous top replaces the optical system 25 in FIG. 1. The prism 35 is disposed substantially in the forward portion (upper in FIG. 3) of the lens 3 of the camera 1.

On a scene object side (upper in FIG. 3) of the prism 35, an optical axis is separated into the left optical axis 30L and the right optical axis 30R on respective oblique lines. On the image formation side (lower in FIG. 3) of the lens 3, there are provided the third left mirror 31L3 corresponding to the left optical axis 30L, and the third right mirror 31R3 corresponding to the right optical axis 30R. The third left mirror 31L3 and the third right mirror 31R3 are so disposed as to form the predetermined angle therebetween, to thereby separate the respective optical paths on the left side and the right side. Moreover, there is disposed the left CCD 32L at the left image formation position, while there is disposed the right CCD 32R at the right image formation position, to thereby constitute the image pick-up optical system. With the thus obtained constitution, the left CCD 32L forms the picture image around the left optical axis 30L on the left side, while the right CCD 32R forms the picture image around the right optical axis 30R on the right side.

The method, operation, and effect of obtaining the stereoscopic picture image with the thus formed picture image according to the second preferred embodiment in FIG. 3 are the same as those according to the first preferred embodiment in FIG. 1. More specifically, each of the right picture image and the left picture image is allowed to be formed by using all the pixels of the respective CCD 32R and the CCD 32L. Thereby, the stereoscopic picture image based on them are free from any deterioration in video quality. Other types of image pick-up element (image pick-up means) such as CMOS and the like can replace the left CCD 32L and the right CCD 32R.

Moreover, according to the first preferred embodiment and the second preferred embodiment, the image-forming means such as the camera 1, the lens 3 and the like may have a zoom function (a function of a lens system). In this case, the left CCD 32L and the right CCD 32R are allowed to have in common a lens system function, to thereby prevent failures such as mismatch (of zoom degree and the like) that is likely to occur when forming images by means of individual (discrete) cameras.

Still furthermore, according to the first preferred embodiment and the second preferred embodiment, the angle defined by the third left mirror 31L3 and the third right mirror 31R3 on the image formation side (lower in FIG. 1 and FIG. 3) of the lens 3 is not limited to those shown, respectively, in FIG. 1 and FIG. 3. Other angle is acceptable provided that the left CCD 32L and the right CCD 32R are disposed at the image formation position corresponding, respectively, to the third left mirror 31L3 and the third right mirror 31R3.

The entire contents of Japanese Patent Application No. P2000-144822 (filed May 17, 2000) is incorporated herein by reference.

Although the invention has been described above by reference to certain embodiments of the invention, the invention is not limited to the embodiments described above. Modifications and variations of the embodiments described above will occur to those skilled in the art, in light of the above teachings. The scope of the invention is defined with reference to the following claims.

What is claimed is:

1. A stereoscopic picture image forming apparatus for forming a picture image of an object separated into a first sub-object for a left eye and a second sub-object for a right eye, the stereoscopic picture image forming apparatus comprising:
a common image-forming means;
a first image pick-up means for picking up the picture image for the left eye, the picture image being introduced by way of the common image-forming means; and
a second image pick-up means for picking up the picture image for the right eye, the picture image being introduced by way of the common image-forming means.

2. The stereoscopic picture image forming apparatus as claimed in claim 1, in which the stereoscopic picture image forming apparatus further comprises an optical means for separating the picture image of the object into the first sub-object for the left eye and the second sub-object for the right eye, and in which each of the first image pick-up means and the second image pick-up means is disposed at an image formation position of the common image-forming means.

3. The stereoscopic picture image forming apparatus as claimed in claim 1, in which the common image-forming means has a zoom function.

4. The stereoscopic picture image forming apparatus as claimed in claim 3, in which the common image-forming means is a lens.

5. The stereoscopic picture image forming apparatus as claimed in claim 2, in which the common image-forming means has a zoom function.

6. The stereoscopic picture image forming apparatus as claimed in claim 5, in which the common image-forming means is a lens.

7. The stereoscopic picture image forming apparatus as claimed in claim 1, in which each of the first image pick-up means and the second image pick-up means comprises a charge coupled device.

8. The stereoscopic picture image forming apparatus as claimed in claim 1, in which each of the first image pick-up means and the second image pick-up means comprises a complementary metal oxide semiconductor.

9. The stereoscopic picture image forming apparatus as claimed in claim 2, in which the optical means comprises a mirror.

10. The stereoscopic picture image forming apparatus as claimed in claim 9, in which the mirror of the optical means comprises:
a pair of a first left mirror and a first right mirror disposed on an external peripheral side of the common image-forming means in such a manner as to oppose to each other, each of the first left mirror and the first right mirror forming a predetermined angle with respect to the common image-forming means; and
a pair of a second left mirror and a second right mirror disposed, respectively, substantially in parallel with the first left mirror and the first right mirror, and disposed in such a position as to oppose to the common image-forming means.

11. The stereoscopic picture image forming apparatus as claimed in claim 2, in which the optical means comprises a prism.

12. The stereoscopic picture image forming apparatus as claimed in claim 2, further comprising a pair of a third left mirror and a third right mirror disposed in such a manner as to form a predetermined angle therebetween,
the third left mirror being so disposed relative to the first image pick-up means as to allow the picture image for the left eye introduced by way of the common image-forming means to reach the first image pick-up means at the image formation position of the common image-forming means, and
the third right mirror being so disposed relative to the second image pick-up means as to allow the picture image for the right eye introduced by way of the common image-forming means to reach the second image pick-up means at the image formation position of the common image-forming means.
